(19) United States
(12) Patent Application Publication
(10) Pub. No.: US 2017/0197475 A1
(43) Pub. Date: Jul. 13, 2017

(54) BICYCLE TYRE

(71) Applicant: Continental Reifen Deutschland GmbH, Hannover (DE)

(72) Inventor: Christian Wurmbäck, Bad Zwesten (DE)

(73) Assignee: Continental Reifen Deutschland GmbH, Hannover (DE)

(21) Appl. No.: 15/326,043

(22) PCT Filed: May 27, 2015
(86) PCT No.: PCT/EP2015/061617

§ 371 Date: Jan. 13, 2017

(30) Foreign Application Priority Data
Jul. 30, 2014 (DE) 10 2014 214 893.6

(51) Int. Cl. B60C 15/00; B60C 9/20

(52) U.S. Cl. CPC B60C 15/0036; B60C 9/2003; B60C 9/2009; B60C 2009/2022; B60C 2200/12; B60C 2009/2077; B60C 2009/2067

(57) ABSTRACT

The invention relates to a bicycle tyre. A puncture-resistant fibre layer (4) having a plurality of polymer, parallel running tyre reinforcing elements (12) is arranged between the tyre tread (2) and the tyre carcass. Said reinforcing elements (12) are arranged at an angle of between approximately 80 and 110 degrees with respect to the peripheral direction (13) of the bicycle tyre.

The invention relates to a bicycle tire. Conventional bicycle tires, in particular racing bicycle tires, are specified and optimized in terms of rolling resistance, puncture protection, and service life.

It is known for bicycle tires to be provided with a cut-resistant fibrous inlay in order for the tire to be protected against puncturing. The relatively rigid material of the cut-resistant fibrous inlay may have a negative influence on the rolling resistance of the bicycle tire.

The invention is based on the object of improving a bicycle tire. In particular, the rolling resistance in the case of racing bicycle tires is to be reduced.

The object is achieved, as per the preamble and the characterizing features of claim 1, in that

a cut-resistant fibrous layer having a multiplicity of strength members, running in parallel, from a polymer are disposed between the running strip and the tire carcass, wherein the strength members are disposed at an angle between approx. 80 and 110 degrees in relation to the circumferential direction of the bicycle tire.

One advantage of the tire according to the invention is to be seen in that the rolling resistance is significantly improved by way of the new tire construction of the bicycle tire, wherein the puncture protection is not simultaneously compromised by the cut-resistant fibrous inlay. In particular, the rolling resistance of the bicycle tire is substantially reduced by the particular arrangement of the strength members at an angle between 80 and 110 degrees in relation to the circumferential direction of the bicycle tire. This surprising effect of the novel arrangement of the strength members has been demonstrated in particular in experiments.

In one advantageous refinement of the invention it is provided that the strength members of the cut-resistant fibrous layer in relation to the circumferential direction of the bicycle tire are disposed substantially at an angle from 85 to 110 degrees, preferably approx. 90 degrees. An optimum value for rolling resistance is achieved in the case of this arrangement of the strength members in the cut-resistant layer.

In one further advantageous refinement of the invention it is provided that the cut-resistant layer in the plan view is approx. 2 to 5 mm narrower than the running strip. On account thereof, the cut-resistant fibrous layer is only disposed in that region of the tire carcass in which cuts are to be normally expected.

In one further advantageous refinement of the invention it is provided that the strength members of the cut-resistant fibrous layer are composed of a liquid-spun polymer, in particular from polyester polyacrylate. This type of strength member is distinguished by a particularly high resistance to cutting.

In one further advantageous refinement of the invention it is provided that the diameter of the strength members is approx. 0.1 to 0.3 mm. On account thereof, the cut-resistant fibrous layer has a relatively low weight.

In one further advantageous refinement of the invention it is provided that the cut-resistant fibrous layer on the lower and the upper side comprises a rubber coating, and has a material thickness of approx. 0.3 to 0.5 mm, preferably of 0.35 mm. On account thereof, the bicycle tire has high puncture protection, wherein the total weight is simultaneously kept low.

In one further advantageous refinement of the invention it is provided that the strength members in the cut-resistant fibrous layer are disposed at a high material density, wherein the spacing of the strength members running in parallel is approx. 50 to 250 strength members per inch. On account thereof, the cut-resistant fibrous layer guarantees high puncture protection.

In one further advantageous refinement of the invention it is provided that a damping rubber inlay from a highly elastic rubber is disposed above the tire carcass, wherein the damping rubber inlay rebound 70 to 80 has a material thickness between 0.2 and 2 mm,

wherein the carcass inlay ends at maximum reach up to the lateral peripheral regions of the running strip.

A damping rubber inlay from a highly elastic rubber in the case of this tire construction is disposed between the running strip and the tire carcass. The ride comfort of the bicycle tire is substantially improved due to the special material thickness of the damping rubber inlay, since the bicycle tire overall is better able to adapt to the ground of the carriageway. Moreover, the carcass inlay ends at maximum reach up to the lateral peripheral regions of the running strip. In this way, the tire carcass below the running strip has high elasticity, on account of which the ride comfort is likewise substantially improved. The new tire construction leads to a substantial improvement of the ride comfort in particular in the case of racing bicycle tires.

In one further advantageous refinement of the invention it is provided that the tire carcass has two carcass inlays, lying on top of one another, wherein the side walls are reinforced and the rolling resistance is reduced by way of the carcass construction. The two carcass inlays, lying on top of one another, lead to a simplification in the manufacturing process of bicycle tires. Moreover, the rolling resistance of the bicycle tire may be reduced by way of this side-wall construction.

In one further advantageous refinement of the invention it is provided that the two carcass inlays, lying on top of one another, cover the entire side wall, and the carcass inlay ends terminate shortly below of the lateral peripheral regions of the running strip. Optimal protection for the side wall is guaranteed in this way.

In one further advantageous refinement of the invention it is provided that the damping rubber inlay has a material thickness between 0.3 and 1 mm. Optimum ride comfort is achieved at this material thickness, wherein the rolling resistance of the bicycle tire is not simultaneously increased.

In one further advantageous refinement of the invention it is provided that the damping rubber inlay is composed of a highly elastic rubber having a material rebound value between 70 and 80.

Optimum ride comfort is achieved at this material rebound value, wherein the rolling resistance of the bicycle tire is not simultaneously increased.

In one further advantageous refinement of the invention it is provided that the bicycle tire is a racing bicycle tire and is operated at a minimum tire pressure of approx. 5.5 bar. The new tire construction may be particularly advantageously employed in racing bicycle tires, since the ride comfort is substantially increased.

The invention is to be explained in greater detail using one exemplary embodiment. The drawings show:

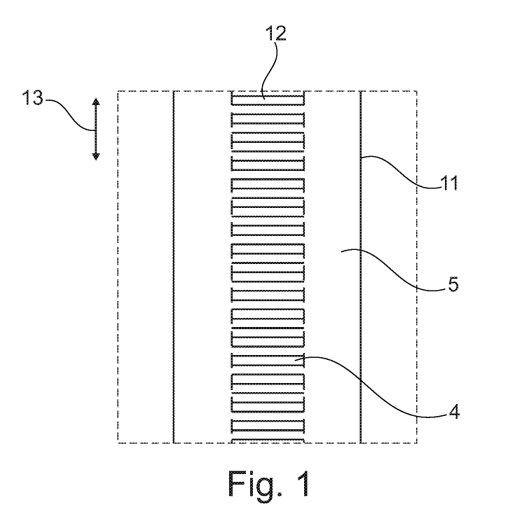

FIG. 1: the cut-resistant fibrous layer in plan view,

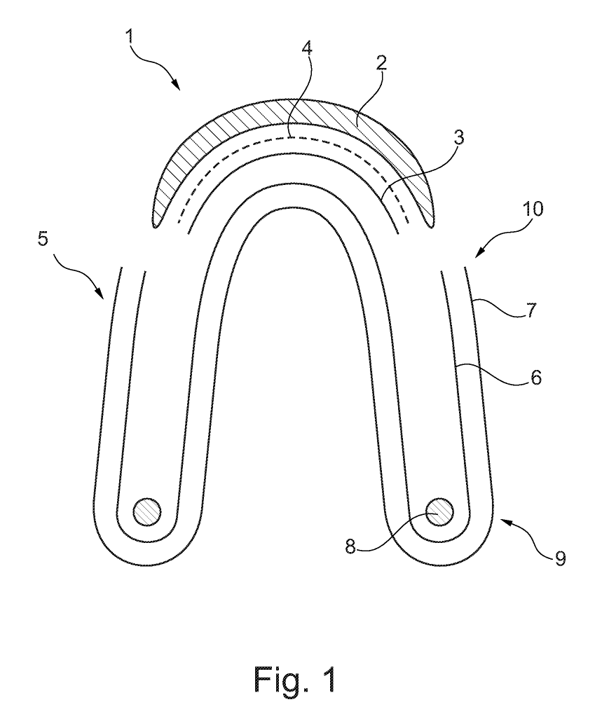

FIG. 2: the bicycle tire in cross section.

FIG. 1 shows the cut-resistant fibrous layer 4 in the plan view. The individual strength members 12 of the fibrous layer 4 are disposed substantially at an angle of approx. 90 degrees to the circumferential direction 13 of the bicycle tire. The components of the bicycle tire are schematically illustrated in the plan view, wherein position 5 indicates the location of the side wall, and position 11 indicates the location of the tire core. A woven fabric (from polyester polyacrylate) which is known by the trademark Vectran may be used as the cut-resistant fibrous layer, for example.

FIG. 2 shows the relevant tire components of the bicycle tire in a cross-sectional view. The bicycle tire illustrated has two carcass inlays 6 and 7, lying on top of one another. The carcass inlay ends 10 are folded back over the core 8 on both sides, reaching so as to be shortly below the lateral regions of the running strip 2. The carcass inlay ends 10 cover the side wall of the racing bicycle tire in a substantially complete manner. Thus, four layers of the woven carcass fabric are disposed on top of one another in the region of the side wall, on account of which the side wall overall has a high rigidity. The damping rubber inlay 3 which preferably has a material thickness between 0.3 and 1 mm is disposed below the running strip 2. The rubber inlay 3 covers the lower side of the running strip 2 in a substantially complete manner. Moreover, the cut-resistant fibrous layer 4 which in the figure is illustrated as a dashed line is disposed below the running strip 2. The cut-resistant fibrous layer guarantees optimum puncture protection and rolling resistance. In the case of the new tire construction the carcass inlay ends 10 do not reach below the running strip, on account of which the ride comfort of the racing bicycle tire is significantly improved. The damping rubber inlay 3 likewise contributes toward increasing the ride comfort.

### LIST OF REFERENCE SIGNS

### Part of the Description

1 Bicycle tire
2 Running strip
3 Damping rubber inlay
4 Cut-resistant fibrous layer (dashed line)
5 Side wall
6 First carcass inlay
7 Second carcass inlay
8 Core
9 Rim strip
10 Carcass inlay ends
11 Position of the core
12 Individual strength member (angular alignment approx.: 90 degrees)
13 Circumferential direction of the bicycle tire

1.-11. (canceled)

12. A bicycle tire comprising a running strip, a tire carcass, tire side walls, and a tire bead having a core;
wherein the tire carcass comprises two carcass inlays lying on top of one another which are folded back over the core and terminate in the side wall;
wherein a cut-resistant fibrous layer comprising a multiplicity of polymer based strength members, running in parallel are disposed between the running strip and the tire carcass, and wherein the strength members are disposed at an angle between approximately 80 and 110 degrees in relation to the circumferential direction of the bicycle tire; and,
wherein the tire side walls are reinforced and the rolling resistance is reduced by way of carcass construction.

13. The bicycle tire as claimed in claim 12, wherein the strength members of the cut-resistant fibrous layer which, in relation to the circumferential direction of the bicycle tire, are disposed substantially at an angle from 85 to 90 degrees.

14. The bicycle tire as claimed in claim 12, wherein the cut-resistant fibrous layer is approximately from 2 to 5 mm narrower than the running strip.

15. The bicycle tire as claimed in claim 12, wherein the strength members of the cut-resistant fibrous layer are composed of a liquid-spun polymer.

16. The bicycle tire as claimed in claim 12, wherein diameter of the strength members is approximately from 0.1 to 0.3 mm.

17. The bicycle tire as claimed in claim 12, wherein the cut-resistant fibrous layer comprises a rubber coating disposed on an upper side and a lower side, wherein the cut-resistant fibrous layer has a material thickness of approximately 0.3 to 0.5 mm.

18. The bicycle tire as claimed in claim 12, wherein the strength members in the cut-resistant fibrous layers are disposed at a high material density, and wherein the spacing of the strength members running in parallel is approximately 50 to 60 strength members per inch.

19. A bicycle tire comprising a running strip, a tire carcass, tire side walls, a tire bead having a core, and a damping rubber inlay disposed above the tire carcass;
wherein the tire carcass comprises at least one carcass inlay which is folded back over the core and terminates in the side wall;
wherein a cut-resistant fibrous layer comprising a multiplicity of polymer based strength members, running in parallel are disposed between the running strip and the tire carcass, and wherein the strength members are disposed at an angle between approximately 80 and 110 degrees in relation to the circumferential direction of the bicycle tire;
wherein the damping rubber inlay comprises a highly elastic rubber, and wherein the damping rubber inlay has a material thickness between 0.2 and 2 mm; and,
wherein ends of the at least one carcass inlay, at maximum, reach up to the lateral peripheral regions of the running strip.

20. The bicycle tire as claimed in claim 19, wherein the damping rubber inlay has a material thickness between 0.3 and 1 mm.

21. The bicycle tire as claimed in claim 19, wherein the strength members of the cut-resistant fibrous layer which, in relation to the circumferential direction of the bicycle tire, are disposed substantially at an angle from 85 to 90 degrees.

22. The bicycle tire as claimed in claim 19, wherein the strength members of the cut-resistant fibrous layer are composed of a liquid-spun polymer.

23. The bicycle tire as claimed in claim 19, wherein diameter of the strength members is approximately from 0.1 to 0.3 mm.

24. The bicycle tire as claimed in claim 19, wherein the cut-resistant fibrous layer comprises a rubber coating disposed on an upper side and a lower side, wherein the cut-resistant fibrous layer has a material thickness of approximately 0.3 to 0.5 mm.

25. The bicycle tire as claimed in claim 19, wherein the strength members in the cut-resistant fibrous layers are disposed at a high material density, and wherein the spacing of the strength members running in parallel is approximately 50 to 60 strength members per inch.

26. A bicycle tire comprising a running strip, a tire carcass, tire side walls, and a tire bead having a core;
wherein the tire carcass comprises at least one carcass inlay which is folded back over the core and terminates in the side wall;
wherein a cut-resistant fibrous layer comprising a multiplicity of polymer based strength members, running in parallel are disposed between the running strip and the tire carcass, and wherein the strength members are disposed at an angle between approximately 80 and 110 degrees in relation to the circumferential direction of the bicycle tire;
wherein the damping rubber inlay comprises a highly elastic rubber, and wherein the damping rubber inlay has a material thickness between 0.2 and 2 mm; and,
wherein the bicycle tire is a racing bicycle tire and is operated at a minimum tire pressure of approximately 5.5 bar.

27. The bicycle tire as claimed in claim 26, wherein the strength members of the cut-resistant fibrous layer are composed of a liquid-spun polymer.

28. The bicycle tire as claimed in claim 26, wherein diameter of the strength members is approximately from 0.1 to 0.3 mm.

29. The bicycle tire as claimed in claim 26, further comprising a damping rubber inlay disposed above the tire carcass, wherein the damping rubber inlay comprises a highly elastic rubber, wherein the damping rubber inlay has a material thickness between 0.2 and 2 mm, and wherein ends of the at least one carcass inlay, at maximum, reach up to the lateral peripheral regions of the running strip.

30. The bicycle tire as claimed in claim 26, wherein the damping rubber inlay has a material thickness between 0.3 and 1 mm.

31. The bicycle tire as claimed in claim 26, wherein the tire carcass comprises two carcass inlays, lying on top of one another, wherein the side walls are reinforced, and wherein rolling resistance is reduced by way of a carcass construction.
